(19) United States
(12) Patent Application Publication
(10) Pub. No.: US 2003/0011876 A1
(43) Pub. Date: Jan. 16, 2003

(54) Apparatus for multiple path interference (MPI) mitigation and method therefore

(76) Inventor: Bernard G. Fidric, Cupertino, CA (US)

Correspondence Address: Jeff Klembczyk, JDS Uniphase Corporation, 570 West Hunt Club Road, Nepean, ON, K2G 5W8, CA

(21) Appl. No.: 10/173,824

(22) Filed: Jun. 19, 2002

Related U.S. Application Data
(60) Provisional application No. 60/305,090, filed on Jul. 12, 2001.

(51) Int. Cl. H01S 3/00

(52) U.S. Cl. 359/337.4

(57) ABSTRACT

A multiple stage fiber amplifier system having optical coupled first and second amplifier stages with optical isolator between the first and second stages of the amplifier system includes an optical bypass element coupled between the first and second for bypassing the optical isolator between the first and second stages of the amplifier system to filter out any signal wavelengths present in the bypass so as not to lead to multiple path interference (MPI) with these same signals propagating directly from the first stage to the second stage of the amplifier system. The bypass element can comprise a fiber with a small coiled radius that scatters out higher signal wavelengths or a lossy fiber that itself scatters out longer wavelengths that are in the optical signal wavelength range.

### CROSS-REFERENCE TO RELATED APPLICATIONS

The present application claims priority to provisional application having serial No. 60/305,090 entitled “Low Cost Multiple Pass Interference Mitigation Method and Apparatus” filed on Jul. 12, 2001 which is incorporated herein by reference.

### FIELD OF THE INVENTION

The present application relates to the field of optical fiber amplifiers and more particularly to two-stage optical amplifiers.

### BACKGROUND OF THE INVENTION

Optical fiber amplifiers are an important component in fiber optical communication systems. Although there are many types of optical amplifiers, the most common type is optical amplifiers constructed using erbium doped optical fiber as the amplifying medium. Such amplifiers are termed EDFA (erbium doped fiber amplifier). For the amplifier to be practical, it should have both high gain, low noise and be simple to construct. It has been found that to meet the gain and noise requirements, amplifiers having two amplifying stages are preferred. U.S. Pat. Nos. 5,392,153 and 5,430,572 provide exemplary designs for two stage optical amplifiers.

The typical two-stage optical amplifier comprises a first stage to provide high gain and low noise amplification of the input signal. The output from this first stage is then optically coupled through an optical isolator and further amplification of the optical signal is obtained. In the erbium doped optical fiber, some excited erbium atoms emit light spontaneously. In particular, spontaneous emissions originating from either end the amplifying optical fiber can also be amplified to attain large intensities at the other end. Thus amplified spontaneous emission (ASE) propagates in both directions through the optical amplifying fiber depleting the gain for the input optical signal and increasing the noise in the optical input signal. The function of the isolator between the two amplifying stages is to suppress this growth in ASE.

EDFAs are optical pumped using lasers that emit light that is absorbed by the erbium ions. Two absorption band regions are used. One absorption band region is centered on 980 nm and the other is centered on 1480 nm. It is well known that a lower noise figure can be obtained using pumping light in the 980 nm wavelength region. However, in the design of the two stage optical fiber amplifiers, using a single pump source, the pump light must pass through the isolator in order to pump the second amplifying stage. This design configuration for the two-stage amplifier requires the isolator to have high transmission at the optical signal wavelengths and the pump wavelength. Standard isolators can transmit 1480 nm light as well as light in the optical signal wavelength range 1525-1625 nm, but have a high insertion loss for pump light in the 980 nm wavelength region. Since it is advantageous to pump with 980 nm light rather than 1480 nm due to the lower noise characteristics of the amplifier with 980 nm pumping, a single 980-nm pump two-stage amplifier is desired.

FIG. 4 of U.S. Pat. No. 5,430,572 discloses a single pump two-stage amplifier design in which the pump light is coupled into the second stage first and thus propagates in the optical fiber in a direction opposite to that of the optical signal light. The pump light that is not used in the second stage is conveyed to the first stage by means of an optical fiber bypass link that permits the pump light to reach the first amplifying stage without having to pass through the optical isolator. This bypass link is implemented as follows. A wavelength division demultiplexer (WDM) device is provided just before the second amplifying stage. The WDM device serves the function to decouple from the optical fiber carrying the optical signal light, the unused backward propagating pump light coming from the second amplifying stage and direct it into the fiber bypass link while at the same time permitting the forward propagating optical signal light to pass through and be optically coupled into the second amplifying stage. From this WDM device the pump light propagates through a short length of fiber to a another WDM device positioned in the optical fiber signal line just after the first amplifying stage. This WDM device optical couples the backward propagating pump light onto the optical fiber carrying the optical signal so that the excess pump light can be used to pump the first amplifying stage. Thus the bypass link provides a means of pumping both stages of the two-stage amplifier using a single laser pump source. It is readily recognized that the same technique could be used to pump the two-stage amplifier with single laser pump source and the pump light and signal light propagating in the same direction.

The use of a bypass link in the design of two-stage optical amplifiers with a single pump source creates another problem, multiple path interference (MPI), that is interference between light signals that travel different paths to reach the same destination. This issue is not discussed in U.S. Pat. No. 5,430,572 within the context of two-stage optical amplifiers with a single pump source. The problem arises because the WDM devices used in implementing the bypass link are not ideal, i.e. complete separation of the pump light from the optical signal light cannot be achieved. In fact if the WDM devices are implemented using fused coupler technology, the isolation between the pump wavelengths and the signal wavelengths can be as low as 15 dB. Consequently, as the optical signal light passes through the WDM device, a small portion of light at the optical signal wavelengths is coupled into the bypass link path. This optical signal light will bypass the optical isolator and in the second WDM device, be coupled back onto the main optical signal fiber line. Since optical signal light that propagated through the isolator and the optical signal light that propagated through the bypass link are related in phase, interference results when these two light signals are combined in the second WDM device. The interference has the detrimental effect of causing the intensity of the optical signal light to vary erratically.

A object of this invention is provide a means to suppress or mitigate against this MPI that can occur in two-stage amplifiers pumped using a single pump and a bypass link.

### SUMMARY OF THE INVENTION

Accordingly, the present invention relates to a multiple stage fiber amplifier system having optical coupled first and second amplifier stages with optical isolator between the first and second stages of the amplifier system which comprises an optical bypass element coupled between the first and second for bypassing the optical isolator between the first and second stages of the amplifier system to filter out any signal wavelengths present in the bypass so as not to lead to multiple path interference (MPI) with these same signals propagating directly from the first stage to the second stage of the amplifier system.

In accordance with an other aspect of the invention there is provided, a multistage optical amplifier system for amplifying an optical signal in a forward direction comprising:

first and second amplifier stages configured to amplify the optical signal propagating in the forward direction in the presence of pump light, from the first amplifier to the second amplifier stage, said first and second stages having an optical isolator disposed therebetween; and,

a bypass element disposed in parallel with the optical isolator for allowing pump light to bypass the optical isolator and to attenuate any signal light propagating through the bypass element.

### BRIEF DESCRIPTION OF THE DRAWINGS

The invention will be described in greater detail with reference to the accompanying drawings which represent preferred embodiments thereof, wherein:

FIG. 1 is a schematic diagram of dual stage EDFA using a single pump source.

FIG. 2 is a schematic diagram of dual stage EDFA using a split pump

FIG. 3 is a schematic diagram of dual stage EDFA with a pump bypass link.

FIG. 4 is a schematic diagram in accordance with the present invention of a dual stage EDFA with a MPI suppression coil in the bypass link.

FIG. 5 is a plot of the loss per turn for light at wavelength 1528 nm in a fiber coil as function of the coil bend diameter.

FIG. 6 is a plot of the loss per turn for light at wavelength 980 nm in a fiber coil as function of the coil bend diameter.

### DETAILED DESCRIPTION

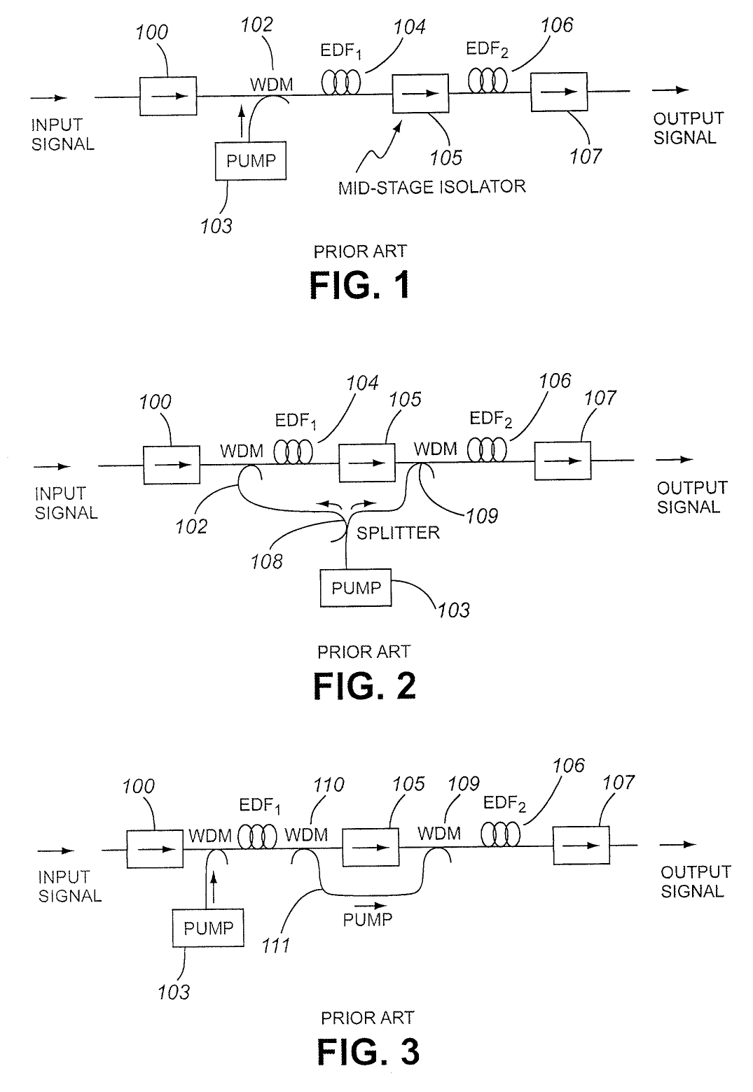

FIG. 1 is a schematic diagram of two-stage or dual stage EDFA with a single pump source. The weak optical signal light emerging from a monomode fiber at the end of lightwave transmission line is coupled into the EDFA through an optical isolator 100. In the EDFA, the signal light is coupled to a WDM multiplexer 102 that combines the light from a pump source 103 with the weak optical signal light. The WDM multiplexer 102 is optically coupled to a first piece of erbium doped fiber 104 in which both the signal light and the pump light propagate through the erbium fiber 104 in the same direction and amplification of the optical light signal occurs. This constitutes the first amplifying stage of the dual stage EDFA. The light output from this first stage, that is both the unused pump light and the amplified signal light are coupled through an optical isolator 105 into the second erbium doped fiber 106, where further amplification of the optical signal light occurs. The light emerging from the second erbium doped fiber consists of primarily amplified optical signal light since the pump light has been substantially absorbed in the erbium doped fiber. The amplified signal light is passed through a final isolator 107 and optical signal coupled into a monomode fiber that forms the next link in the lightwave transmission line.

In this design for the dual stage EDFA, the pump light must pass through the isolator. As already noted the transmission of standard optical isolators at a pump wavelength of 980 nm is low, consequently, this design for a dual stage EDFA is better suited to using a pump wavelength of 1480 nm, which is a wavelength at which the optical isolator has a higher transmission. In order to use 980 nm pumping and obtain the benefits of lower noise amplification, it is necessary to design a dual stage EDFA architecture that avoids the pump light passing through the optical isolator 104.

U.S. Pat. No. 5,430,572 disclosed a design for a dual stage EDFA which uses an optical splitter 108 to split the pump light from the single pump source 103 into two parts. This design configuration is shown in FIG. 2. One part of the pump light is transmitted to the WDM multiplexer 102 for use in pumping the first erbium doped fiber 104 and other part is transmitted to a WDM multiplexer 109 positioned in front of the second erbium doped fiber 106 for use in pumping the second erbium doped fiber 106. Since the splitter 108 divides the pump power in a fixed ratio, the pump powers delivered to the two amplifying stages may not be optimum resulting in some wastage of pump power. A preferred configuration for a single pump dual stage EDFA is shown in FIG. 3.

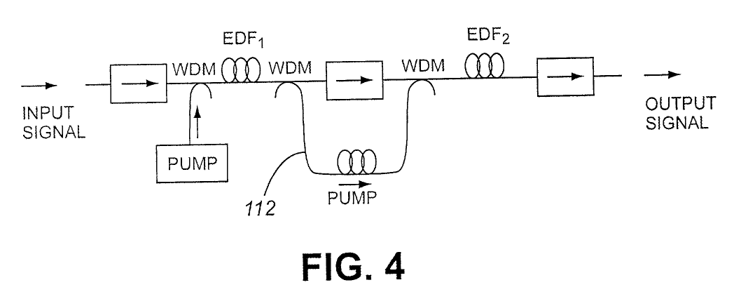

FIG. 3 shows a single pump dual stage EDFA with an optical bypass link 111. The function of the bypass link is to provide a route for the pump light around the optical isolator 105. The bypass link is implemented as follows. A WDM demultiplexer 110 is situated in the optical path between the output from the first amplifying fiber 104 and the input to the optical isolator 105. Its function is to receive the light output from first amplifying fiber 104 and separate the unused pump light at the pump wavelength from the amplified optical signal light at the signal wavelengths in order to send the signal light to the optical isolator 105 and the pump light through the bypass fiber 111. Another WDM device 109 is positioned in the optical path between the output optical isolator 105 and the input to the second amplifying fiber 106. Its function is to receive the pump light propagating through the bypass fiber and combine it with the signal light transmitted through the optical isolator and optically couple both pump light and signal light into the second amplifying fiber 106. FIG. 4 of U.S. Pat. No. 5,430,572 discloses another embodiment of this single pump dual stage EDFA in which the pump light propagates through the amplifier in a direction counter to the direction for optical signal propagation.

A problem with the EDFA configuration of FIG. 3 which uses a bypass link, is that multiple path interference (MPI) can occur. MPI arises because the WDM device 110 is not ideal. That is, the WDM device 110 cannot completely separate the pump light at the pump wavelength from the signal light at the signal wavelengths. As already noted, isolation between pump wavelength light and signal wavelength light for WDM devices based on fused coupler technology can be as low as 15 dB. Thus some light at the signal wavelengths is directed by the WDM device 110 through the bypass fiber 111. This signal light is related in phase to the primary optical signal light that is sent through the optical isolator 105. Consequently, when the primary optical signal light is combined by the WDM device 109 with the optical signal light that traveled a different optical path by the bypass route, interference occurs resulting in signal power fluctuations. Thus this design for a single pump dual stage EDFA is not usable.

A solution to this MPI problem is to make the loss of the bypass fiber 111 in FIG. 3 wavelength dependent. That is to make the bypass optical path have a high insertion loss for light at the signal wavelengths and a low insertion loss light at the pump wavelength.

FIG. 4 shows one embodiment of the invention that offers a low cost, easy to implement a solution to eliminate this MPI problem. The preferred low cost element comprises a short, small bend diameter fiber coil 112 made of fiber with a short cut-off wavelength, e.g., Corning HI-1060, also known as Flexcor™, which is illustrated in FIG. 4 as replacing the bypass fiber 111 in FIG. 3,

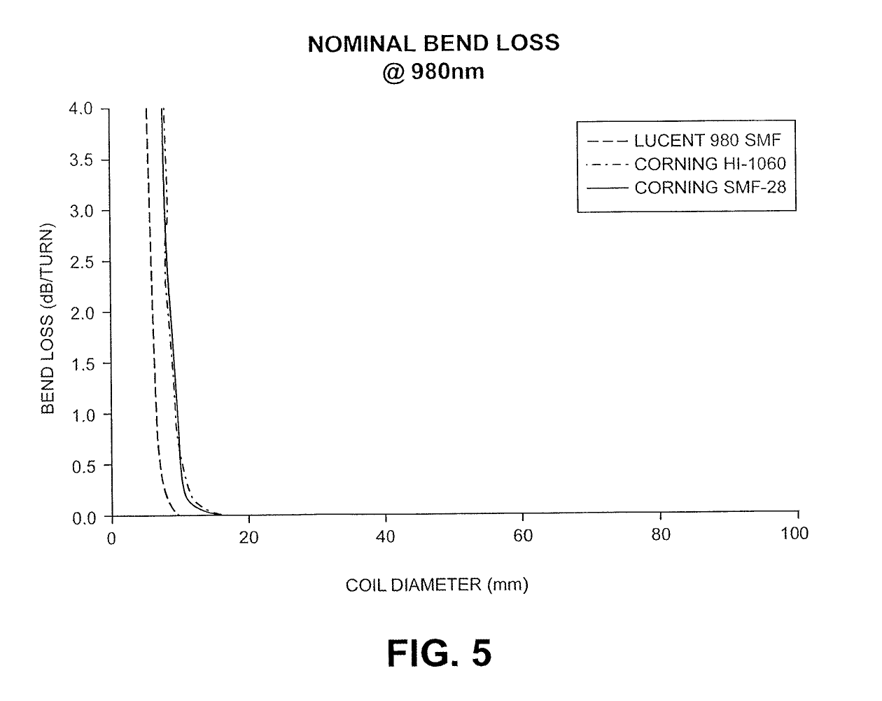

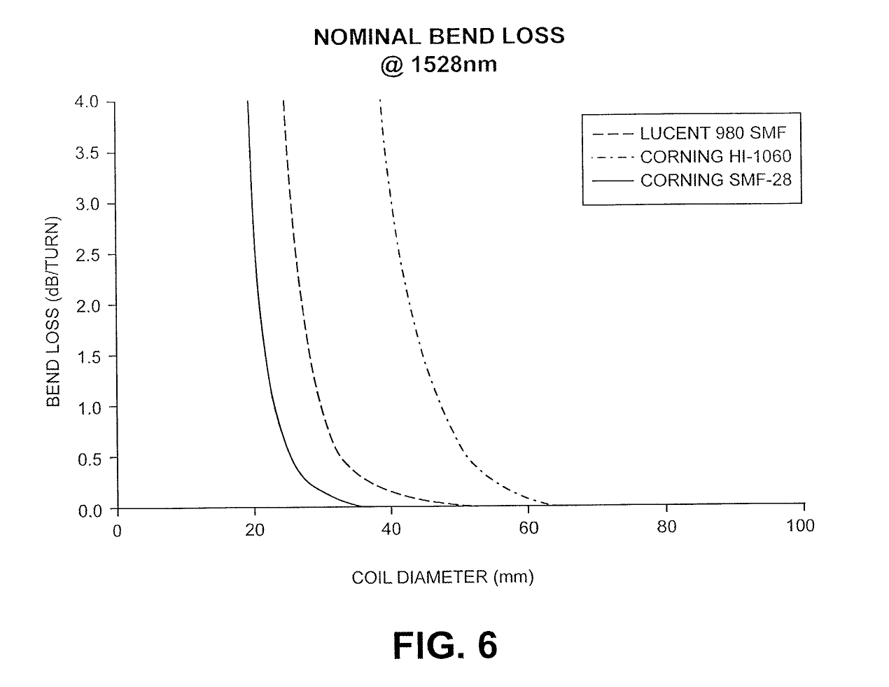

Computer calculations of the loss experienced by light in propagating through a fiber coil have been made. FIG. 5 is a plot of the bend loss per turn for light at a wavelength of in optical signal band (1528 nm) as a function of the bend radius for three different fibers—Corming SMF-28, Coming HI-1060 and Lucent 980 SMF. Note that in the case of the Corning HI-1060 fiber and a bend diameter of 1 inch (25.4 mm), the loss per turn is greater than 2.5 dB for light at a wavelength of 1528 nm. FIG. 6 is a similar plot of the loss per turn as a function of bend diameter except the light wavelength is 980 nm. Note that for a bend diameter of 25 mm the loss per turn at 980 nm is negligible. Thus the computer simulations indicate a 10 turn coil of Corning HI-1060 fiber incurs an insertion loss of greater than 25 dB for light at the signal wavelengths whereas the light at the 980 nm pump wavelength will experience almost negligible transmission loss. This result has also been demonstrated experimentally as well.

Another alternative to this invention is a fiber that is specially designed to transmit light at short wavelengths corresponding to the pump wavelength with a low attenuation, but have a high attenuation for light with wavelengths in the optical signal wavelength region. In such fiber, the mode field diameter for light at the pump wavelengths is of the order of the fiber core diameter whereas the mode field diameter at the signal wavelengths is substantially larger. These specialty fibers are available upon request from 3M Corporation or Lucent. The higher attenuation at the signal wavelengths in the specialty fiber is obtained by designing the fiber to be leaky, i.e. to radiate light power in the optical signal wavelength region. Thus, when light at the pump wavelengths is launched into such a fiber it is confined primarily to fiber core whereas when light at the signal wavelengths is launched into such a fiber, it is loosely bound to the fiber core with the light field extending a relatively large distance into the cladding into what is termed the evanescent region. Consequently, as light at the signal wavelength propagates through this fiber, the light attenuation is high due to induced radiative losses by micro-bends in the fiber and absorptive losses of the evanescent which extends to the glass/jacketing boundary of the optical fiber.

With such a specialty fiber, MPI suppression in this second embodiment can be obtained by replacing the coil 112 in FIG. 4 with a length of this specialty fiber that is sufficiently long to incur a 25 dB insertion loss for the light at the optical signal wavelength.

This invention is also applicable to amplifier systems having more than two stages where multiple bypass elements of this invention would be employed bypassing optical isolators between consecutively coupled fiber amplifier stages.

Although the invention has been described in conjunction with one or more preferred embodiments, it will be apparent to those skilled in the art that other alternative, variations and modifications will be apparent in light of the foregoing description as being within the spirit and scope of the invention. Thus, the invention described herein is intended to embrace all such alternatives, variations and modifications as that are within the spirit and scope of the following claims.

What is claimed is:

1. A multiple stage fiber amplifier system having optically coupled first and second amplifier stages with optical isolator between the first and second stages of the amplifier system comprising:
an optical bypass element coupled between the first and second amplifier stages for bypassing the optical isolator between the first and second stages of the amplifier system to filter out any signal wavelengths present in the bypass so as not to lead to multiple path interference (MPI) with these same signals propagating directly from the first stage to the second stage of the amplifier system.

2. The multiple stage fiber amplifier system as defined in claim 1 wherein the optical bypass element includes a coiled fiber.

3. The multiple stage fiber amplifier system of claim 2 wherein the coiled fiber has at least ten turns or more.

4. The multiple stage fiber amplifier system of claim 2 wherein the coiled fiber comprises a Corning HI-1060 (a.k.a. Flexcor™) fiber coiled about a one inch diameter core.

5. The multiple stage fiber amplifier system of claim 2 wherein the coiled fiber in the bypass element is an attenuating element for attenuating signal wavelengths passing therethrough.

6. The multiple stage fiber amplifier system of claim 1 wherein the bypass element comprises a fiber that is lossy for signal wavelengths but transmissive of pump wavelengths.

7. A multistage optical amplifier system for amplifying an optical signal in a forward direction comprising:
first and second amplifier stages configured to amplify the optical signal propagating in the forward direction in the presence of pump light, from the first amplifier to the second amplifier stage, said first and second stages having an optical isolator disposed therebetween; and,
a bypass element disposed in parallel with the optical isolator for allowing pump light to bypass the optical isolator and to attenuate any signal light propagating through the bypass element.

8. An optical amplifier system as defined in claim 7, wherein the substantially most of the signal light propagating through the bypass element is attenuated.

9. An optical amplifier system as defined in claim 7 wherein the bypass element includes a wavelength dependent element for directing most of the signal light through the isolator and for directing most of the pump light through the parallel path to avoid the optical isolator.

10. An optical amplifier as defined in claim 9 wherein the wavelength dependent element is a wavelength dependent coupler.

11. An optical amplifier system as defined in claim 10, wherein the substantially most of the signal light propagating through the bypass element is attenuated.

12. An optical isolator as defined in claim 7 wherein pump light propagating through the bypass element is directed to propagate to the second stage.

13. An optical isolator as defined in claim 7 wherein pump light propagating through the bypass element is directed to propagate to the first stage.
